(19) United States
(12) Patent Application Publication
(10) Pub. No.: US 2010/0013819 A1
(43) Pub. Date: Jan. 21, 2010

(54) PLASMA DISPLAY PANEL APPARATUS DRIVING METHOD AND PLASMA DISPLAY PANEL APPARATUS

(76) Inventors: Keiji Akamatsu, Osaka (JP); Kenji Ogawa, Osaka (JP); Mitsuo Ueda, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 11/916,051

(22) PCT Filed: Jun. 8, 2006
(86) PCT No.: PCT/JP2006/311558

§ 371 Date: Nov. 30, 2007

(30) Foreign Application Priority Data
Jun. 9, 2005 (JP) 2005-168998

(51) Int. Cl. G06F 3/038

(52) U.S. Cl. 345/213; 345/60

(57) ABSTRACT

In a former half (T₁₁) of an all-cell reset period (T₁), the potential of a scan electrode (Scn) is raised from 0 [V] to Vp [V] at a timing t0, and thereafter maintained at the positive potential of Vp [V] to Vg [V] until a timing t3 when the former half (T₁₁) ends. On the other hand, in the same former half (T₁₁), a reset pulse (Pul.2), which includes a negative ramp waveform portion from 0 [V] to a potential of Vr [V], is applied to a sustain electrode (Sus). A time period (t1−t0) of the negative ramp waveform portion of the pulse (Pul.2) is set longer than a time period required for the potential change of a pulse (Pul.1) from P1 to P2.

### TECHNICAL FIELD

The present invention relates to a plasma display panel apparatus and a driving method for the same, and in particular to technology for suppressing the generation of erroneous discharges in a reset period during driving.

### BACKGROUND ART

A surface-discharge alternating-current type plasma display panel (hereinafter, simply called a “PDP”), which has currently become mainstream among various plasma display panels, has the following structure. In the PDP, two panels have been disposed in opposition to each other with an interval therebetween, an outer circumferential portion of the panels has been sealed, and a discharge gas that includes Xe has been filled into the interval. One of the two panels constituting the PDP (here, the front panel) includes a glass substrate having display electrode pairs (each including a scan electrode and a sustain electrode) formed on a main surface thereof, and a dielectric layer and a protective film that have been laminated thereon in the stated order so as to cover the display electrode pairs.

On the other hand, the other of the two panels (here, the back panel), includes a glass substrate having address electrodes formed on the main surface thereof that faces the front panel, and a dielectric layer that has been laminated thereon so as to cover the address electrodes. Also, barrier ribs have been formed in a stripe configuration, waffle configuration, or the like on the surface of the dielectric layer of the back panel. The barrier ribs have portions that run parallel to the address electrodes, and stand between pairs of neighboring address electrodes. The barrier ribs function as a gap material between the front panel and back panel. Depressions are formed on the back panel by the formation of the barrier ribs, and either a red (R), green (G), or blue (B) light emitting phosphor layer has been formed in each of the depressions. Note that the front panel and back panel have been disposed such that the display electrode pairs on the front panel and the address electrodes on the back panel cross each other.

In a PDP apparatus that includes a PDP as a display device, the PDP is connected to a driving circuit. The driving circuit of the PDP apparatus mainly includes drivers connected to the electrodes and a driving control unit that is connected to the drivers and outputs, with use of a subfield method (intrafield time-division gradation display method), driving signals based on a video signal that is input to the apparatus.

In the driving of the PDP apparatus, gradation display is performed by time-dividing each field into a number of brightness-weighted subfields, and controlling the lighting state in the subfields. The subfields are allocated write periods during which a write discharge is generated between one electrode of the display electrode pair (here, the scan electrode) and the address electrode in selected discharge cells in order to form a wall charge, and a sustain period during which an alternating current is applied to the display electrode pair of all of the discharge cells in order to sustain the wall charges formed in the selected discharge cells (e.g., see patent document 1).

However, in the driving of the PDP apparatus, issues in terms of image quality arise if there is simply a series of the subfields composed of a write period and a sustain period as described above, due to the remaining history of the wall charge of a previous subfield, and therefore an all-cell reset period is provided in each field. The all-cell reset period is a period during which a reset discharge is generated in all of the discharge cells of the PDP at once in order to erase the history of the wall charge of the previous subfield and form a wall charge in preparation for a write operation. The waveform of the pulse applied to the electrodes in the all-cell reset period is described below with reference to FIG. 11.

As shown in FIG. 11, in the all-cell reset period, a pulse applied to electrodes Scn, Sus, and Dat is configured such that two weak discharges (reset discharges) are generated. In terms of time, the portion of the period that includes the first occurrence of the weak discharge is called the former half, and the portion of the period that includes the later occurrence of the weak discharge is called the latter half. In the former half of the all-cell reset period, the potentials of the sustain electrode Sus and the address electrode Dat are set to 0 [V], and thereafter a voltage having a rising ramp waveform that gradually rises from a potential Vq [V] toward a potential Vr [V] is applied to the scan electrode Scn. Then, the first weak discharge occurs during the rise of the potential of the scan electrode Scn from Vq [V] to Vr [V], where the scan electrode Scn is the anode and the sustain electrode Sus and address electrode Dat are the cathode.

Next, in the latter half of the all-cell reset period, the potential of the sustain electrode is set to Vh [V] while sustaining the 0 [V] potential of the address electrode Dat, and thereafter a voltage having a falling ramp waveform that gradually falls from a potential Vg [V] toward a potential Va [V] is applied to the scan electrode Scn. Then, the second weak discharge occurs during the fall of the potential of the scan electrode Scn from Vg [V] to Va [V], where the sustain electrode Sus and address electrode Dat are the anode and the scan electrode Scn is the cathode. As described above, the generation of the second weak discharge in the all-cell reset period causes the reset of all the discharge cells of the PDP.

However, in recent years, the proportion of the Xe partial pressure with respect to the total pressure of the discharge gas has been increased, as one way of improving the luminous efficiency of PDPs. In PDPs having an increased proportion of Xe partial pressure in the discharge gas, there are cases in which, as shown in FIG. 11, a strong discharge occurs when the original weak discharge is to occur in the all-cell reset period. In particular, if a strong discharge occurs in the former half of the all-cell reset period, there are cases in which a strong discharge occurs in the latter half as well due to the influence of the strong discharge in the former half. The strong discharge generated in the latter half of the all-cell reset period forms the same wall charge state as if a write operation were performed in a write period, which leads to a reduction in image quality.

One exemplary approach to solving the above problem is a method in which an auxiliary erase pulse is applied to the scan electrode Scn of all discharge cells directly after the all-cell reset period has ended (see patent document 2). In the technology proposed by patent document 2, applying the auxiliary erase pulse to the scan electrode Scn directly after the all-cell reset period erases the excess wall charge, thereby enabling suppressing the generation of erroneous discharges during the sustain period.

Patent document 1: Japanese Patent Application Publication No. 2000-242224

Patent document 2: Japanese Patent Application Publication No. 2004-191530

### DISCLOSURE OF THE INVENTION

### Problems Solved by the Invention

However, in the technology of patent document 2, since the auxiliary erase pulse is applied to the scan electrode Scn in all discharge cells directly after the all-cell reset period, the wall charge states of discharge cells in which a strong discharge has not occurred are effected as well. For this reason, when the technology of patent document 2 is employed, the margin of the applied voltage in the write period becomes narrower. Here, the margin refers to the range of the applied voltage necessary to generate a normal write discharge.

Also, when the technology of patent document 2 is employed, although the application of the auxiliary erase pulse enables erasing the abnormal wall charge of discharge cells in which a strong discharge occurred in the all-cell reset period, a write discharge cannot be generated during the following write period in such discharge cells whose wall charges have been erased, and therefore sustain discharges are not generated in the sustain periods of the subfields. For this reason, when the technology of patent document 2 is employed, gradation is sacrificed in the driving of the PDP apparatus when strong discharges are generated in the all-cell reset period, which leads to a reduction in image quality.

Also, when the technology of patent document 2 is employed, the waveform of the auxiliary erase pulse must be set very strictly, which makes ensuring the design margin difficult. Specifically, if the width of the auxiliary erase pulse is too narrow, it is possible that an erase discharge will not be generated due to a discharge delay, whereas being too wide causes wall charge to be accumulated and an erroneous discharge to occur. Although setting a low height (voltage value) and a wide width for the auxiliary erase pulse enables avoiding the accumulation of wall charge, when variations in properties between discharge cells in a panel are taken into consideration, ensuring the design margin becomes difficult when there is a desire to stably generate erase discharges.

Also, since the technology of patent document 2 does not aim to prevent the generation of strong discharges in the all-cell reset period, screen flickering occurs due to discharges etc. caused by the strong discharges and the application of the auxiliary erase pulse, thereby bringing about a reduction in image quality.

Furthermore, in recent years, definition has been increasing for compatibility with full-spec high vision etc., and along with such increases in definition, the voltage applied to address electrodes in the write period has tended to rise. This is due to the need to be able to reliably perform writing without be influenced by the rise in discharge interference between adjacent discharge cells that comes along with the increase in definition.

In the former half of the all-cell reset period, the voltage Vx [V] applied to the address electrodes is desirably set to the same value as the voltage applied to the address electrodes during the write period, in consideration of apparatus cost and circuit structure. The rise in the voltage applied to the address electrodes during the write period, which is a countermeasure against discharge interference between adjacent discharge cells, therefore also leads to a rise in the voltage Vx [V] applied to the address electrodes in the all-cell reset period. Therefore, in such a case, a discharge tends to be started not only in a region in which the discharge starting voltage has risen, but also from the reset at the aforementioned-voltage value, and such a discharge is a factor for causing discharge interference in low gradation regions. Accordingly, flickering more readily occurs in low gradation regions in PDP apparatuses as definition is increased.

The present invention has been achieved in order to solve the above problems, and an aim thereof is to provide a PDP apparatus driving method and a PDP apparatus that can reliably suppress the generation of erroneous discharges in an all-cell reset period without narrowing the voltage margin for write discharges, even when the voltage applied to address electrodes is increased for an increased definition, and can furthermore suppress flickering in low gradation regions in order to achieve high image quality.

### Means to Solve the Problems

In order to achieve the above aim, the present invention has the following structure.

A driving method for a PDP apparatus pertaining to the present invention is a driving method for a plasma display panel apparatus which includes a panel unit that has a plurality of electrode pairs, each including a first electrode and a second electrode, that has a plurality of third electrodes which cross the electrode pairs with a discharge space therebetween, and in which a plurality of discharge cells are constituted at a plurality of intersecting portions between the electrode pairs and the third electrodes, an all-cell reset period for resetting a wall charge state of all of the discharge cells being assigned in a field that includes a plurality of brightness-weighted subfields, wherein the all-cell reset period is divided into a first section in which a first reset discharge is generated and a second section in which a second reset discharge is generated, in at least one of the first section and the second section, a change in a potential of the first electrodes is begun, the change being toward a potential that is less than a discharge starting voltage between the first electrodes and the third electrodes, and in conjunction with a timing thereof, a potential of the second electrodes is changed inversely with respect to a polarity of the potential of the first electrode by a ramp waveform portion of a voltage waveform applied to the second electrodes, and a duration of the ramp waveform portion from a beginning to an end of the potential change of the second electrodes is longer than a duration from when the potential change of the first electrodes is begun until the potential that is less than the discharge starting voltage has been reached.

Also, in a PDP apparatus pertaining to the present invention, a drive unit uses the above-described driving method of the present invention to execute display driving with respect to a panel unit.

### EFFECTS OF THE INVENTION

According to the PDP apparatus and driving method for the same pertaining to the present invention, in at least one of the first section and second section, the potential of the first electrodes is changed to the above-described potential state, and the ramp waveform voltage is applied to the second electrodes either while the potential of the first electrodes is changing or at the above-described potential state. The set time of the ramp waveform portion (the time from the beginning of the change to the end of the change) is set longer than the time required for the potential of the first electrodes to reach the above-described potential. Therefore, according to the PDP apparatus and driving method for the same pertaining to the present invention, a stable weak discharge can be generated between the first electrodes and second electrodes in the section employing the method for setting the potential in the all-cell reset period, and this weak discharge is used as priming for generating a weak discharge between the first electrodes and third electrodes.

Also, according to the PDP apparatus and driving method for the same pertaining to the present invention, even when the ramp waveform voltage is applied to the second electrodes in the all-cell reset period, depending on the voltage value thereof, there are cases in which an opposing discharge is first generated between the second and third electrodes. However, since the second electrodes are cathodes and the third electrodes are anodes in the opposing discharge of the reset operation, this opposing discharge is more stable than an opposing discharge in which the third electrodes are cathodes. Therefore, according to the PDP apparatus and driving method for the same pertaining to the present invention, a stable reset discharge can be generated even with this type of discharge.

In the technology disclosed in patent document 2, an auxiliary erase pulse is applied after the all-cell reset period has ended, thereby narrowing the margin for the write discharge in the writing period following thereafter. However, according to the PDP apparatus and driving method for the same pertaining to the present invention, a stable reset discharge can be reliably generated without applying an auxiliary erase pulse such as in patent document 2. Therefore, according to the PDP apparatus and driving method for the same pertaining to the present invention, there is no narrowing of the margin for the write discharge in the writing period following the all-cell reset period.

In the technology disclosed in patent document 2, an auxiliary erase pulse is applied after the all-cell reset period has ended, thereby erasing the accumulated wall charge and inhibiting the generation of a sustain discharge in the sustain period. However, according to the PDP apparatus and driving method for the same pertaining to the present invention, the wall charge is not erased, and the generation of a sustain discharge in the sustain period is not inhibited.

Also, according to the PDP apparatus and driving method for the same pertaining to the present invention, the generation of erroneous discharges in the all-cell reset period can be reliably suppressed without applying a narrow auxiliary erase pulse such as in patent document 2, thereby sufficiently ensuring design margins.

Therefore, according to the PDP apparatus and driving method for the same pertaining to the present invention, the generation of erroneous discharges in the all-cell reset period can be reliably suppressed without narrowing the voltage margin for write discharges, thereby enabling a high image quality. Also, the PDP apparatus and driving method for the same pertaining to the present invention enable reliably suppressing flickering in low gradation areas even if the voltage applied to the third electrodes (address electrodes) has been raised along with an increase in definition.

According to the PDP apparatus and driving method for the same pertaining to the present invention, as described above, the above effects can be obtained by employing the reset operation in at least one of the first section and the second. However, it is desirable to employ the reset operation in, in particular, the first section for generating a reset discharge in which the first electrodes are anodes and the second electrodes are cathodes. Here, normally a protective film (a film composed of MgO etc.) has been formed on the side of the discharge space where the second electrodes have been formed, and a phosphor layer has been formed on the side of the discharge space where the third electrodes have been formed. Therefore, the secondary electron emission coefficient of the phosphor layer is smaller than that of the protective film, and an opposing discharge in which the third electrodes are cathodes is more unstable than an opposing discharge in which the third electrodes are anodes. In other words, applying the above-described structure to the first section for generating a discharge in which the first electrodes are anodes enables first generating a stable weak discharge between the first electrodes and second electrodes, which is effective in view of the stability of the discharge. Note that in this case, the ramp waveform of the voltage applied to the second electrode has a negative slope.

Also, in the conventionally used PDP apparatus driving method, the first section is generally set to come before the second section in the all-cell reset period, and if an erroneous discharge (strong discharge) occurs in the first section for the above-described reason, the erroneous discharge effects the wall charge, and there is a higher probability that a strong discharge will occur in the second section as well due to the influence on the wall charge formation from the generation of the strong discharge in the first section. It is desirable for this reason as well to employ the reset operation pertaining to the present invention in the first section of the all-cell reset period.

Furthermore, employing the above-described structure in the first section is superior in terms of image quality since there is no low-brightness flickering such as in the technology of patent document 2.

Also, in the PDP apparatus and driving method for the same pertaining to the present invention, it is desirable to set the potential of the third electrodes to the same polarity as the potential of the first electrodes in the section in which the ramp waveform voltage is applied to the second electrodes. This is because changing the potential of the third electrodes in this section toward the same polarity as the potential of the first electrodes enables reliably first generating a weak discharge between the first electrodes and second electrodes.

Also, in the PDP apparatus and driving method for the same pertaining to the present invention, it is desirable to perform setting of the all-cell reset period having the above structure in accordance with the average picture level (APL) in the image of the respective field. In other words, when an image with a high APL is to be displayed, there is less dark image display area, and for this reason, a higher proportion of the subfields constituting the field are set so as to include the all-cell reset period. This enables stabilizing write discharges in the field, and furthermore enables stabling discharges by the increase in the amount of priming.

Also, in the PDP apparatus and driving method for the same pertaining to the present invention, it is desirable in terms of stabilizing the reset discharge to set the timing of beginning the application of the ramp waveform voltage to the second electrodes to within 1 [μsec.] before or after the timing of beginning the setting of the first electrodes to the above-described potential.

Also, according to the structure pertaining to the present invention, although the above-described effects can be obtained regardless of the partial pressure rate of Xe in the discharge gas, a high amount of Xe, where the partial pressure of Xe is at least 7 [%] of the total pressure of the discharge gas, is particularly effective.

### BRIEF DESCRIPTION OF THE DRAWINGS

FIG. 1 is a perspective view showing an extracted relevant portion of a panel unit 10, in the structure of a PDP apparatus 1 pertaining to embodiment 1;

FIG. 2 is a block diagram showing a schematic structure of the PDP apparatus 1;

FIG. 3 is a waveform diagram showing voltage waveforms that are applied to electrodes Scn, Sus, and Dat in periods T₁ to T₄ during driving of the PDP apparatus 1;

FIG. 4 is a detailed waveform diagram showing voltage waveforms applied to the electrodes Scn, Sus, and Dat in an all-cell reset period T₁ during driving of the PDP apparatus 1;

FIG. 5 is a flowchart showing steps S1 to S15 that are performed by a display drive unit 20 in the all-cell reset period T₁ during driving of the PDP apparatus 1;

FIG. 6 is a schematic diagram showing a relationship between a counter value CT counted by a timing generator 24 in the all-cell reset period T₁ and waveforms of the voltages applied to the electrodes Scn, Sus, and Dat during driving of the PDP apparatus 1;

FIG. 7 is a subfield structure diagram showing an exemplary structure of subfields SF₁ to SF₁₀ in a field during driving of the PDP apparatus 1;

FIG. 8A is a detailed waveform diagram showing voltage waveforms applied to the electrodes Scn, Sus, and Dat during the all-cell reset period T₁ in a driving method pertaining to variation 1, and FIG. 8B is a detailed waveform diagram showing voltage waveforms applied to the electrodes Scn, Sus, and Dat during the all-cell reset period T₁ in a driving method pertaining to variation 2;

FIG. 9 is a detailed waveform diagram showing voltage waveforms applied to the electrodes Scn, Sus, and Dat during an all-cell reset period T₅ in a driving method pertaining to variation 3;

FIG. 10 is a waveform diagram showing voltage waveforms applied to the electrodes Scn, Sus, and Dat during an all-cell reset period T₆ in a driving method for a PDP apparatus pertaining to embodiment 2; and

FIG. 11 is a waveform diagram showing voltage waveforms applied to the electrodes Scn, Sus, and Dat during an all-cell reset period in a driving method for a PDP apparatus pertaining to conventional technology.

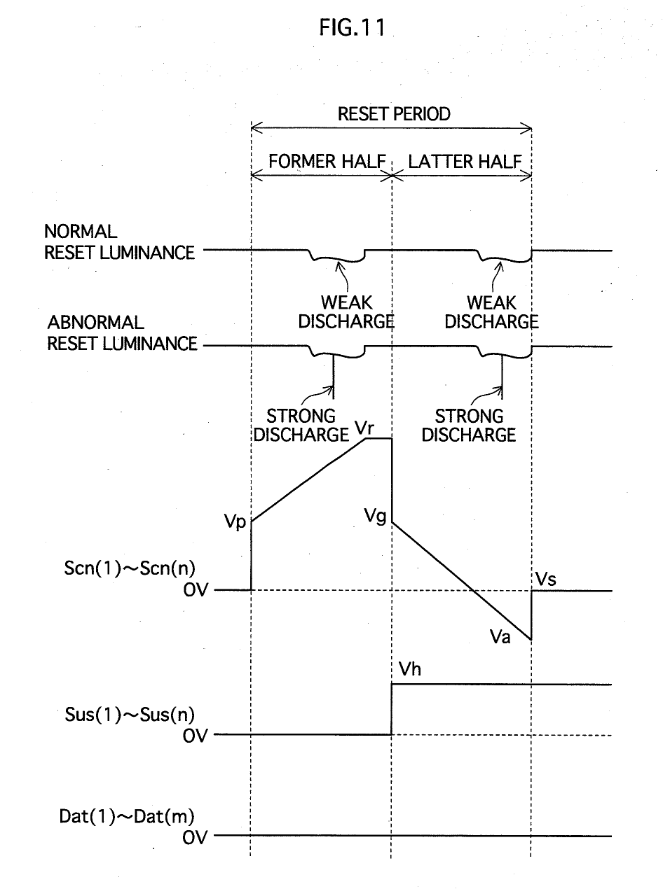

### DESCRIPTION OF THE CHARACTERS

1. plasma display panel apparatus
10. panel unit
11. front panel
12. back panel
20. display drive unit
21. address driver
22. scan driver
23. sustain driver
24. timing generator
25. A/D converter
26. scan count converter
27. subfield converter
28. APL detector
111. front substrate
112. display electrode pair
113, 122. dielectric layer
114. protective film
121. back substrate
123. barrier rib
124. phosphor layer
1121, 1122. transparent electrode element
1123, 1124. bus electrode element
1231. main barrier rib
1232. auxiliary barrier rib
Scn. scan electrode
Sus. sustain electrode
Dat. address electrode

### BEST MODE FOR CARRYING OUT THE INVENTION

The following describes best modes for carrying out the present invention, based on examples. The embodiments described below are nothing more than examples, and the present invention should not be limited to such embodiments.

### Embodiment 1

1. Structure of Panel Unit 10

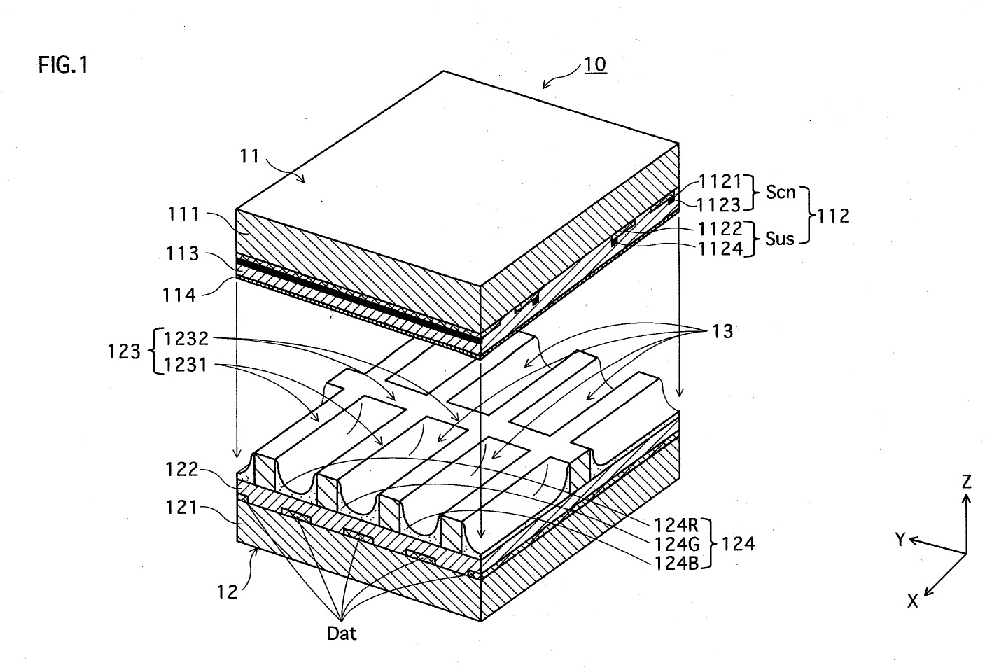

The structure of a panel unit 10, which is a portion of the structure of a PDP apparatus 1 pertaining to embodiment 1 of the present invention, is described below with reference to FIG. 1. FIG. 1 is a perspective view (partial cross-sectional view) showing a relevant portion of the structure of the panel unit 10 pertaining to embodiment 1.

As shown in FIG. 1, the panel unit 10 has a structure in which two panels 11 and 12 have been disposed in opposition with a discharge space 13 therebetween.

1-1. Structure of Front Panel 11

As shown in FIG. 1, a front panel 11 corresponding to the panel 11 constituting the panel unit 10 includes a front substrate 111, display electrode pairs 112 that are each composed of a scan electrode Scn and a sustain electrode Sus and that have been disposed in parallel on a surface (in FIG. 1, the bottom surface) of the front substrate 111 that faces a back panel 12 corresponding to the panel 12 constituting the panel unit 10, and a dielectric layer 113 and a protective film 114 that have been formed in the stated order so as to cover the display electrode pairs 112.

The front substrate 111 is constituted from, for example, high strain point glass or soda lime glass. Also, the scan electrodes Scn and sustain electrodes Sus are constituted from wide transparent electrode elements 1121 and 1122 respectively that are composed of ITO (tin-doped indium oxide), SnO₂ (tin oxide), ZnO (zinc oxide) or the like, and bus electrode elements 1123 and 1124 respectively that have been formed from Cr(chrome)-Cu (copper)-Cr (chrome), Ag (silver) or the like for lower electrical resistance.

Also, the dielectric layer 113 has been formed from a Pb—B type low melting point glass material, and the protective film 114 includes MgO (magnesium oxide) or MgF₂-(magnesium fluoride) as a main material.

Note that black stripes may be provided between adjacent pairs of display electrode pairs 112 on the surface of the front substrate 111 in order to prevent light from one discharge cell leaking into another discharge cell.

1-2. Structure of Back Panel 12

The back panel 12 includes a back substrate 121, address electrodes Dat disposed on a surface (in FIG. 1, the top surface) of the back substrate 121 that faces the front panel 11, in an orientation substantially orthogonal to the display electrode pairs 112, and a dielectric layer 122 that has been formed so as to cover the address electrodes Dat. Also, main barrier ribs 1231 have been provided standing on the dielectric layer 122 between adjacent address electrodes Dat, and furthermore, auxiliary barrier ribs 1232 have been formed in an orientation substantially orthogonal to the main barrier ribs 1231. In the panel unit 10 of the present embodiment, the combination of the main barrier ribs 1231 and auxiliary barrier ribs 1232 constitutes barrier ribs 123. Note that, although not depicted in detail in FIG. 1, the top edge of the auxiliary barrier ribs 1232 has been set to be slightly lower (e.g., roughly 10 [μm] to 20 [μm]) than the top edge of the main barrier ribs 1231 in the z direction.

Phosphor layers 124 have been provided on the dielectric layer 122 and inner wall surfaces of recessed portions surrounded by two adjacent main barrier ribs 1231 and two adjacent auxiliary barrier ribs 1232. The phosphor layers 124 are divided into red (R) phosphor layers 124R, green (G) phosphor layers 124G, and blue (B) phosphor layers 124B, which have been formed in sequence in the y direction of FIG. 1 in the recessed portions divided by the main barrier ribs 1231. Note that each row between adjacent main barrier ribs 1231 in the x direction of FIG. 1 has formed therein a different one of the phosphor layers 124R, 124G, or 124B.

Similarly to the front substrate 111, the back substrate 121 of the back panel 12 is constituted from high strain point glass or soda lime glass. The address electrodes Dat are composed of a metal material such as silver (Ag), and have been formed on the surface of the back substrate 121 by screen-printing a silver paste. Note that besides Ag, the material composing the address electrodes Dat can be a metal material such as gold (Au), chrome (Cr), copper (Cu), nickel (Ni), or platinum (Pt), or can be, for example, a combination of such materials formed by a method of lamination.

Basically similarly to the dielectric layer 113 of the front panel 11, the dielectric layer 122 is composed of a Pb—B type low melting point glass material, but may include aluminum oxide (Al₂O₃) or titanium oxide (TiO₂). Also, the barrier ribs 123 are formed using, for example, a lead glass material.

The phosphor layers 124R, 124G, and 124B are each formed from, for example, one color of phosphor such as shown below, or are formed from a combination of materials.

| | |
|---|---|
| red (R) phosphor | (Y,Gd)BO₃: Eu |
| | YVO₃: Eu |
| green (G) phosphor | Zn₂SiO₄: Mn |
| | (Y,Gd)BO₃: Tb |
| | BaAl₁₂O₁₉: Mn |
| blue (B) phosphor | BaMgAl₁₀O₁₇: Eu |
| | CaMgSi₂O₆: Eu |

1-3 Disposition of Front Panel 11 and Back Panel 12

The panel unit 10 has a structure in which the front panel 11 and the back panel 12 sandwich the barrier ribs 123 formed on the back panel 12 as a gap material, such that the display electrode pairs 112 and the address electrodes Dat are arranged substantially orthogonal to each other, and outer circumferential portions of the front and back panels 11 and 12 have been sealed together. According to this structure, a discharge space 13 sectioned by the barrier ribs 123 is formed between the front and back panels 11 and 12, which form a hermitically sealed container. A discharge gas composed of a mixture of Ne gas, Xe gas, He gas, etc. has been filled into the discharge space 13. The charged pressure of the discharge gas is, for example, 50 [kPa] to 80 [kPa].

Note that although the ratio of the Xe partial pressure to the total pressure of the discharge gas is conventionally set to below 7 [%], in recent years, the ratio of the Xe partial pressure has been set to 7 [%] or more with the aim of increasing the brightness of the panel, and furthermore there is a trend of higher settings of 10 [%] or more.

In the panel unit 10, discharges cells (not depicted) correspond to places where the display electrode pairs 112 and the address electrodes Dat cross each other. Also, a plurality of the discharge cells are arranged in the panel unit 10 in a matrix configuration.

2. Structure of PDP Apparatus 1

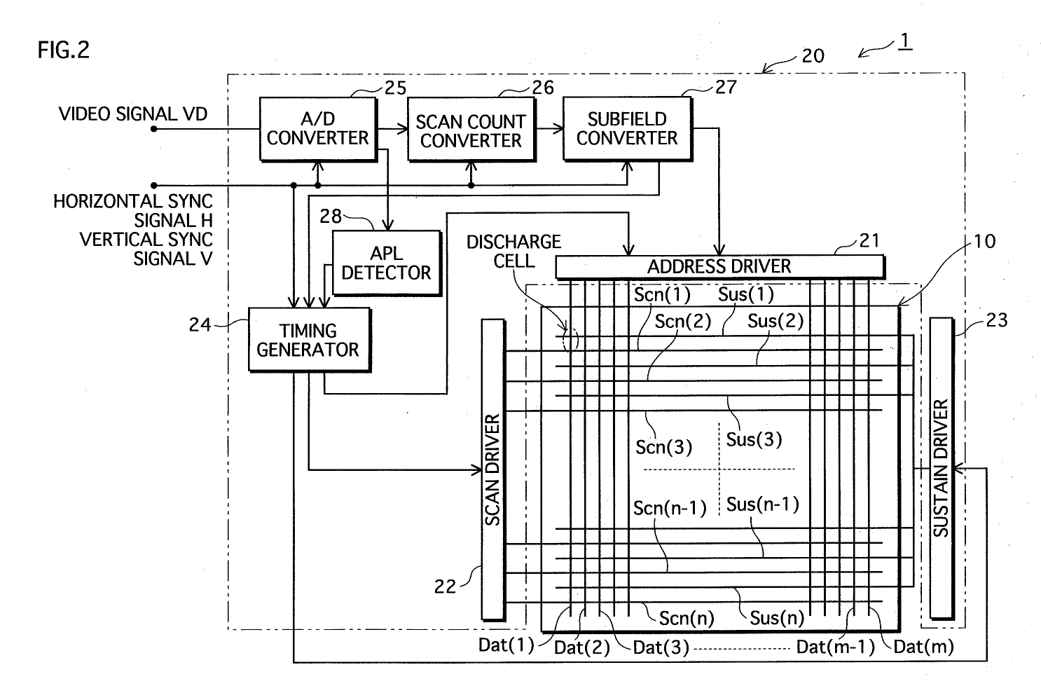

The following describes the PDP apparatus 1 that includes the panel unit 10, with reference to FIG. 2. FIG. 2 is a block diagram that schematically shows the structure of the PDP apparatus 1. Note that regarding the panel 10, only the arrangement of the electrodes Scn, Sus, and Dat is shown in FIG. 2.

As shown in FIG. 2, the PDP apparatus 1 pertaining to the present embodiment includes the panel unit 10 and a display drive unit 20 that applies voltages having predetermined waveforms to the electrodes Scn, Sus, and Dat at predetermined timings. In the panel unit 10, n scan electrodes Scn(1) to Scn(n) and n sustain electrodes Sus(1) to Sus(n) have been disposed alternately in the row direction. Also, in the panel unit 10, m address electrodes Dat(1) to Dat(m) have been disposed in the column direction. Discharge cells correspond to intersecting portions between an address electrode Datl (l=from 1 to m) and adjacent pairs of scan electrodes Scnk (k=from 1 to n) and sustain electrodes Susk (k=from 1 to n), and the panel unit 10 has a total of (m×n) discharge cells.

As shown in FIG. 2, the display drive unit 20 includes an address driver 21, a scan driver 22, and a sustain driver 23 that are connected to the electrodes Scn, Sus, and Dat in the panel unit 10. In addition to the drivers 21 to 23, the display drive unit 20 includes a timing generator 24, an A/D converter 25, an operation converter 26, a subfield converter 27, and an APL (Average Picture Level) detector 28. Although not depicted in FIG. 2, the display drive unit 20 has a power supply circuit. A video signal VD is input to the A/D converter 25, and a horizontal sync signal H and a vertical synch signal V are input to the timing generator 24, the A/D converter 25, the scan count converter 26, and the subfield converter 27.

The A/D converter 25 of the display drive unit 20 converts the received video signal VD to image data in the form of a digital signal, and outputs the post-conversion image data to the scan count converter 26 and the APL detector 28. For each screen received from the A/D converter 25, the APL detector 28 counts a total of all gradation values in the screen based on display screen data that shows the gradation value of each discharge cell, and divides the total by the number of discharge cells to obtain a value (APL value). The APL detector 28 then obtains the average picture level by calculating the percentage of the obtained value with respect to the maximum gradation value (e.g., 256 gradations), and outputs the resulting value to the timing generator 24. A screen with a lower average picture level value is darker, and a screen with a higher value is lighter.

The scan count converter 26 converts the image data received from the A/D converter 25 to image data that is in accordance with the number of pixels in the panel unit 10, and outputs the resulting image data to the subfield converter 27. The subfield converter 27 includes a subfield memory (not depicted), and converts the image data received from the scan count converter 26 to subfield data, which is a collection of 2-value data indicating lit/unlit states of discharge cells for causing the panel unit 10 to display gradations, and temporarily stores the subfield data in the subfield memory. The subfield converter 27 then outputs the subfield data to the address driver 21 in accordance with a timing signal received from the timing generator 24.

The address driver 21 converts the image data of each subfield into signals corresponding to the address electrodes Dat(1) to Dat(m), and drives the address electrodes Dat. The address driver 21 includes a widely known driver IC, etc.

The timing generator 24 generates a timing signal based on the horizontal sync signal H and the vertical sync signal V, and outputs the timing signal to the drivers 21 to 23. Here, the timing generator 24 determines, based on the APL value input from the APL detector 28, whether each reset period of the subfields constituting a field is an all-cell reset period or a selective reset period, and controls how many times the all-cell reset period is applied in the field.

The scan driver 22 applies a drive voltage to the scan electrodes Scn(1) to Scn(n) in accordance with the timing signal output by the timing generator 24. Similarly to the address driver 21, the scan driver 22 includes a widely known driver IC, etc.

The sustain driver 23, includes a widely known driver IC, and applies a drive voltage to the sustain electrodes Sus(1) to Sus(n) in accordance with the timing signal output by the timing generator 24.

3. Driving Method for PDP Apparatus 1

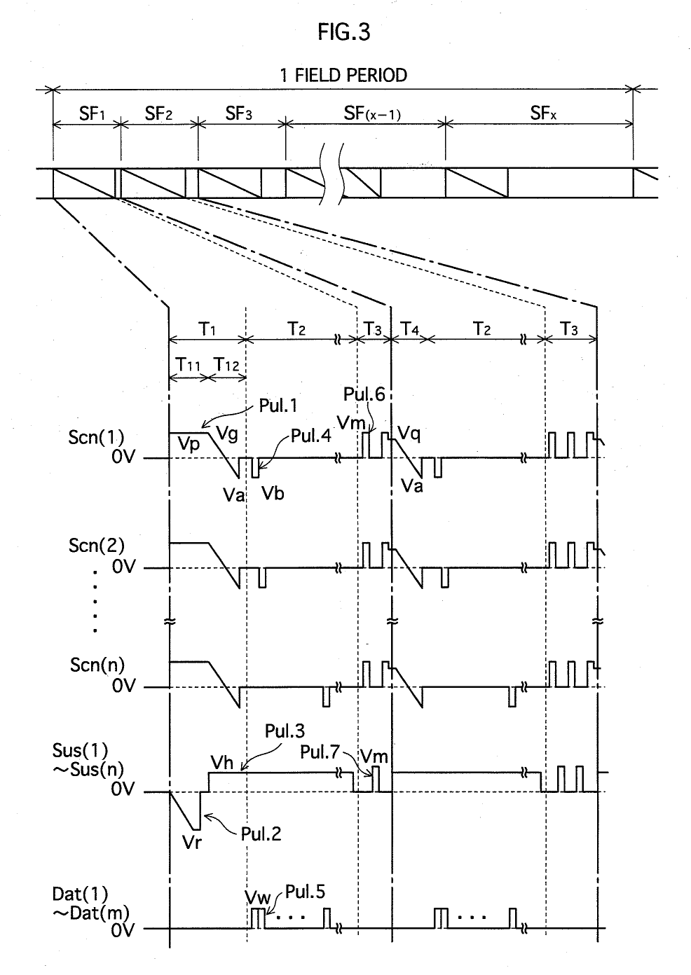

The following describes a driving method for the PDP apparatus 1 having the above-described structure, with reference to FIG. 3. FIG. 3 shows a method for driving the PDP apparatus 1 with use of an intrafield time-division gradation display method (subfield method).

As shown in FIG. 3, in the driving of the PDP apparatus 1, a field is time-divided into X subfields SF₁ to SF_{X}, and the number of sustain pulses Pul.6 and Pul.7 is set such that the brightness relative ratio of each of the subfields SF₁ to SF_{X} is 1:2:4:˜:2^{(X-1)}. Also, controlling the lighting states in the subfields SF₁ to SF_{X} in accordance with the display brightness data enables performing a display with 2^{X} gradations by the combination of the X subfields. Note that although 2⁽ⁱ⁻¹⁾ sustain pulses are allocated to each SFi of the subfields SF₁ to SF_{X} in the present embodiment, the present invention is not limited to this.

As shown in FIG. 3, the subfields SF₁ to SF_{X} have write periods T₂ and sustain periods T₃, as well as either an all-cell reset period T₁ or a selective reset period T₄. The following describes the all-cell reset period T₁ and the selective reset period T₄, and the write period T₂ and the sustain period T₃.

3-1. All-Cell Reset Period T₁

In the all-cell reset period T₁, a reset discharge is generated in all of the discharge cells of the panel unit 10 at the same time to erase the history of the wall charge in the immediately preceding subfield SF, and furthermore to form a wall charge distribution that is necessary for the writing operation in the write period T₂ coming thereafter.

As shown in FIG. 3, in the all-cell reset period T₁, a reset pulse Pul.1 is applied to the scan electrodes Scn(1) to Scn(n). The reset pulse Pul.1 has a waveform that changes from ground potential to a positive potential Vp [V], and after becoming potential Vg [V], changes to a negative potential Va [V] by a ramp waveform that has a negative slope, and thereafter returns to 0 [V]. Here, the rising potential portion in the reset pulse Pul.1 from 0 [V] to the potential Vp [V] has a very steep slope. For example, the potential rises to Vp [V] in 1 [nsec.] to 500 [nsec.]. Note that the waveform and timing of the reset pulse Pul.1 are described later.

Also, in the all-cell reset period T₁, a reset pulse Pul.2 is applied to the sustain electrodes Sus(1) to Sus(n). The reset pulse Pul.2 has a negative ramp waveform portion that falls from 0 [V] to a potential Vr [V], and thereafter returns to 0 [V] when the potential of the scan electrodes Scn(1) to Scn(n) reaches Vg [V]. Thereafter, a reset pulse Pul.3 for sustaining a positive potential Vh [V] is applied to the sustain electrodes Sus(1) to Sus(n). The potential Vh [V] of the sustain electrodes Sus(1) to Sus(n) is maintained in the following write period T₂ as well. Note that reset pulses Pul.2 and Pul.3 applied to the sustain electrodes Sus(1) to Sus(n) in the all-cell reset period T₁ are described later.

The potential of the address electrodes Dat(1) to Dat(m) in the all-cell reset period T₁ is maintained at 0 [V] through the entire period.

Also, in the all-cell reset period T₁, the first reset discharge occurs while the potential of the reset pulse Pul.2 applied to the sustain electrodes Sus(1) to Sus(n) falls from 0 [V] to Vr [V], and the second reset discharge occurs while the potential of the reset pulse Pul.1 applied to the scan electrodes Scn(1) to Scn(n) falls from Vg [V] to Va [V]. In the present embodiment, the interval in which the first reset discharge is generated is called the former half T₁₁, and the interval in which the second reset discharge occurs is called the latter half T₁₂.

Note that regarding the two reset discharges generated during the all-cell reset period T₁, the first reset discharge generated during the former half T₁₁ is a weak discharge in which the scan electrodes Scn(1) to Scn(n) are each anodes and the sustain electrodes Sus(1) to Sus(n) and the address electrodes Dat(1) to Dat(m) are each cathodes, and the second reset discharge generated during the latter half T₁₂ is a weak discharge in which the scan electrodes Scn(1) to Scn(n) are cathodes, and the sustain electrodes Sus(1) to Sus(n) and the address electrodes Dat(1) to Dat(m) are anodes.

In all of the discharge cells in the PDP apparatus 1, the generation of the two reset discharges in the all-cell reset period T₁ erases the wall charge histories and forms the wall charge distribution state, and the discharge cells are primed in order to reduce discharge delays and stabilize write discharges during the write period T₂ (excited particles are initiating agents for the discharges).

3-2. Selective Reset Period T₄

Also, the selective reset period T₄ is applied in the subfield SF₂ in the present embodiment. In the selective reset period T₄, reset discharges are selectively generated in discharge cells in which a sustain discharge occurred in the immediately preceding subfield SF.

As shown in FIG. 3, in the selective reset period T₄, the potential of the sustain electrode Sus(1) to Sus(n) is maintained at Vh [V], and the potential of the address electrodes Dat(1) to Dat(m) is maintained at 0 [V]. Also, a voltage having a falling ramp waveform that gradually falls from potential Vq [V] to potential Va [V] is applied to the scan electrodes Scn(1) to Scn(n).

In the selective reset period T₄/the reset operation enables selectively causing weak reset discharges to be generated in discharge cells in which a sustain discharge occurred in the immediately preceding subfield SF. These reset discharges attenuate the wall charge on the scan electrodes Scn and the sustain electrodes Sus, that is to say, on the surface of the protective film 114 on the front panel 11, and adjust the wall charge on the surface of the address electrodes Dat, that is to say, on the surface of the phosphor layer 124, to a value suited for a write operation.

3-3. Write Period T₂

In the write period T₂, the potential of the scan electrodes Scn(1) to Scn(n) is initially set to 0 [V]. Next, a write pulse Pul.5 having an amplitude Vw [V] is applied to, from among the address electrodes Dat(1) to Dat(m), an address electrode Dat(i) in a discharge cell that is to perform display in a first row, and a negative-polarity write pulse Pul.4 having an amplitude Vb [V] is applied to the scan electrodes Scn(1) in the first row. At this time, the voltage at the intersection of the address electrode Dat(i) and the scan electrode Scn(1) is the sum of the external applied voltage (Vw−Vb) [V], the wall charge on the address electrode Dat(i), and the wall charge on the scan electrode Scn(1), which exceeds the discharge starting voltage.

As a result of such a write discharge, in the selected discharge cells, write discharges are generated between the address electrode Dat(i) and the scan electrode Scn(1), and between the scan electrode Scn(1) and the sustain electrode Sus(1), a positive wall charge is formed on the scan electrode Scn(1), and a negative wall charge is formed on the sustain electrode Sus(1) and the address electrode Dat(i). In this way, the write discharges form wall charges on the electrodes Scn(1), Sus(1), and Dat(i) in the discharge cell that is to perform display in the first row.

However, since the voltage at the intersection of the scan electrode Scn(1) and the address electrode Dat to which the write pulse Pul.5 was not applied does not exceed the discharge starting voltage, a write discharge does not occur. In the write period T₂, the above series of write operations is performed sequentially through the discharge cell of the nth row, and thereafter ends.

3-4. Sustain Period T₃

In the sustain period T₃, first the potential of the sustain electrodes Sus(1) to Sus(n) is returned to 0 [V], and a sustain pulse Pul.6 having an amplitude of Vm [V] is applied to the scan electrodes Scn(1) to Scn(n). Here, the voltage between the scan electrode Scn(j) and the sustain electrode Sus(j) is the sum of the sustain pulse Pul.6 having the amplitude Vm [V] and the magnitude of the wall charges on the scan electrode Scn(j) and the sustain electrode Sus(j), which exceeds the discharge starting voltage. Also, a sustain discharge occurs between the scan electrode Scn(j) and the sustain discharge Sus(j), whereby a negative wall charge is formed on the scan electrode, and a positive wall charge is formed on the sustain electrode Sus(j). At this time, a positive wall charge is formed on the address electrode Dat as well in the discharge cell.

A sustain discharge does not occur in discharge cells in which a write discharge was not generated in the write period T₂, even if the sustain pulse Pul.6 is applied. For this reason, the wall charge state at the end of the reset periods T₁ and T₄ is maintained in these discharge cells.

Next, the potential of the scan electrodes Scn(1) to Scn(n) is returned to 0 [V], and a sustain pulse Pul.7 having the amplitude Vm [V] is applied to the sustain electrodes Sus(1) to Sus(n). As a result of the sustain pulse Pul.7, in the discharge cell in which the sustain discharge was generated by the application of the pulse Pul.6 to the scan electrodes Scn(1) to Scn(n), the voltage between the scan electrode Scn(j) and the sustain electrode Sus(j) exceeds the discharge starting voltage, and a sustain discharge occurs. A sustain discharge does not occur in the subfield SF in discharge cells in which a sustain discharge was not generated by the application of the pulse Pul.6 to the scan electrodes Scn(1) to Scn(n).

In the sustain period T₃, sustain discharges are consecutively generated by alternately and repeatedly applying the pulse Pul.6 to the scan electrodes Scn(1) to Scn(n) and the pulse Pul.7 to the sustain electrodes Sus(1) to Sus(n). Brightness weighting in the subfields SF₁ to SF_{X} is performed by the frequency of occurrences of such sustain discharges.

Note that at the end of the sustain period T₃, a so-called narrow pulse is applied between the scan electrodes Scn(1) to Scn(n) and the sustain electrodes Sus(1) to Sus(n) The application of the narrow pulse erases the wall charge on the scan electrodes Scn(1) to Scn(n) and the sustain electrodes Sus(1) to Sus(n) while sustaining the positive wall charge on the address electrode Dat(i).

4. Details of the Voltage Waveforms Applied to the Electrodes Scn, Sus, and Dat in the all-Cell Reset Period T₁

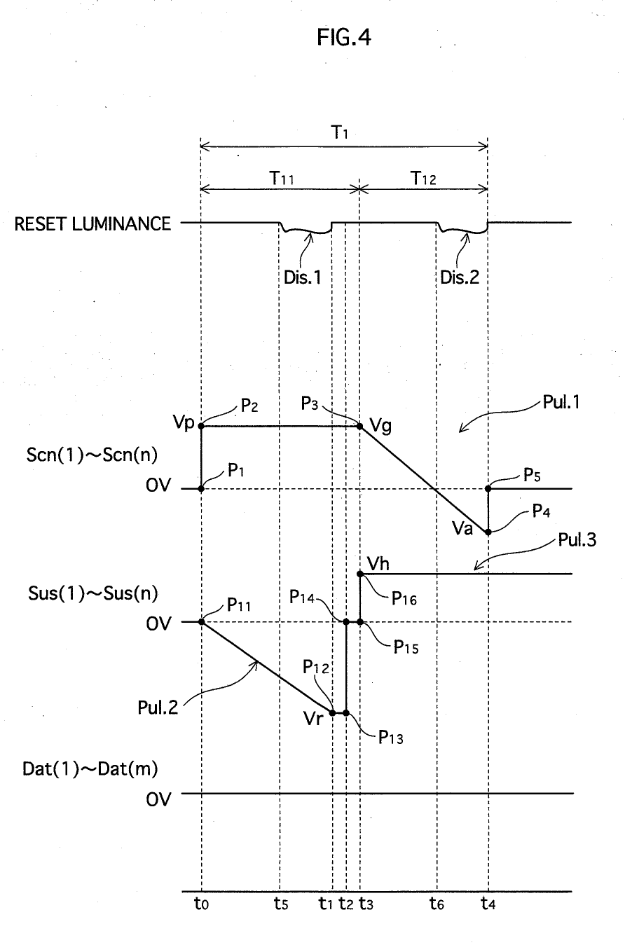

The following describes details of the all-cell reset period T₁, which is the most characteristic feature in the driving method of the PDP apparatus 1 pertaining to the present embodiment, with reference to FIG. 4.

As shown in FIG. 4, in the former half T₁₁ of the all-cell reset period T₁, at timing t0 the potential of the scan electrodes Scn(1) to Scn(n) is raised from 0 [V] to Vp [V] (the portion from point P1 to point P2), and thereafter is maintained between the positive potentials Vp [V] and Vg [V] until a timing t3 when the former half T₁₁ ends is reached. Note that the potential Vp [V] at point P2 and the potential Vg [V] at point P3 may be the same or different.

Also, the potential of the scan electrodes Scn(1) to Scn(n) in the latter half T₁₂ of the all-cell reset period T₁ changes from the potential Vg [V] to the negative potential Va [V] (the portion from point P3 to point P4) by a ramp waveform that has negative slope from timing t3 to timing t4. Thereafter, the potential of the scan electrodes Scn(1) to Scn(n) changes to 0 [V] at a timing t4 (the portion from point P4 to point P5).

On the other hand, the potential of the sustain electrodes Sus(1) to Sus(n) is changed from 0 [V] to Vr [V] (the portion from point P11 to point P12) during the interval from timing t0 to timing t1 by a ramp waveform that has a negative slope. Thereafter, the potential of the sustain electrodes Sus(1) to Sus(n) is maintained at Vr [V] during the interval from timing t1 to timing t2 (the portion from point P12 to point P13), and is rapidly changed to 0 [V] at timing t2 (the portion from point P13 to point P14). Then, the potential of the sustain electrodes Sus(1) to Sus(n) is maintained at 0 [V] during the interval from timing t2 to timing t3 (the portion from point P14 to P15).

Also, the reset pulse Pul.3 applied to the sustain electrodes Sus(1) to Sus(n) in the latter half T₁₂ is for maintaining the potential thereof at the positive Vh [V] throughout the entirety of the latter half T₁₂ (from point P16 on).

During the all-cell reset period T₁, in all of the discharge cells of the panel unit 10 of the PDP apparatus 1, the above-described reset operation generates a first reset discharge Dis.1 after timing t5 in the former half T₁₁, and a second reset discharge Dis.2 after timing t6 in the latter half T₁₂. As mentioned above, in the all-cell reset period T₁, the generation of the reset discharges Dis.1 and Dis.2 erases the wall charge history and adjusts the wall charge distribution state, and primes discharge cells in order to reduce discharge delays and stabilize write discharges during the write period T₂ (excited particles are initiating agents for the discharges).

Here, the most characteristic feature of the driving method of the PDP apparatus 1 pertaining to the present embodiment is the portion in which the reset pulse Pul.2, which includes the negative ramp waveform portion (the portion from point P11 to point P12), is applied to the sustain electrodes Sus(1) to Sus(n) in the former half T₁₁ of the all-cell reset period T₁. Also, in the driving method of the PDP apparatus 1, the time period required for the ramp waveform portion of the reset pulse Pul.2, that is to say (t1−t0), is set longer than the time period required for the potential change in the portion from point P1 to point P2 in the reset pulse Pul.1 (e.g., 1 [nsec.] to 500 [nsec]).

Also, in the present embodiment, the ramp waveform of the portion from point P11 to point P12 in the reset pulse Pul.2 in the all-cell reset period T₁ refers to, for example, a waveform that has a gradual slope of 9 [V/μsec.] or less. A description thereof has been omitted since details are described in, for example, “ASIA DISPLAY '98, pp. 23-27”.

Note that as one variation of the reset operation, a slope that is more gradual than in the present embodiment can be set for the portion of the reset pulse Pul.1 from point P1 to point P2. However, even if the portion from point P1 to point P2 is given a more gradual slope as described above, it is important for the time period thereof to be set shorter than the time period (t1−t0) required for the portion of the reset pulse Pul.2 from point P11 to point P12.

5. Advantages of the PDP Apparatus 1 and the Driving Method for the Same

As described above, in the driving method for the PDP apparatus 1 pertaining to the present embodiment, in the former half T₁₁ of the all-cell reset period T₁, the reset pulse Pul.1 is applied to the scan electrodes Scn(1) to Scn(n), and the reset pulse Pul.2 having a negative ramp waveform portion is applied to the sustain electrodes Sus(1) to Sus(n). Also, the time period required for the change in the ramp waveform portion of the reset pulse Pul.2 in the former half T₁₁, that is to say the time period (t1−t0) required from point P11 to point P12 of FIG. 4, is set longer than the time period required from point P1 to point P2 of the reset pulse Pul.1 applied to the scan electrodes Scn(1) to Scn(n) (e.g., 1 [nsec.] to 500 [nsec.]).

In the former half T₁₁ of the all-cell reset period T₁ that employs such a reset operation, the weak discharge (reset discharge) Dis.1 occurs in all the discharge cells of the panel unit 10, where the scan electrodes Scn(1) to Scn(n) are anodes, and the sustain electrodes Sus(1) to Sus(n) and the address electrodes Dat(1) to Dat(m) are cathodes. In the former half T₁₁ of the driving method for the PDP apparatus 1 employing the above-described reset operation, a weak discharge is first generated between the scan electrodes Scn(1) to Scn(n) and the sustain electrodes Sus(1) to Sus(n), and due to being primed by the occurrence of this weak discharge, a weak discharge is generated in between the scan electrodes Scn(1) to Scn(n) and the address electrodes Dat(1) to Dat(m). The reset discharge Dis.1 in the former half T₁₁ is made up of these two weak discharges whose order of occurrence is determined such as above.

Accordingly, in the driving of the PDP apparatus 1 pertaining to the present embodiment, all of the discharge cells can be reliably reset while suppressing the erroneous occurrence of discharges in the all-cell reset period T₁.

In the driving of a PDP apparatus that employs technology pertaining to the aforementioned patent document 2, an auxiliary erase pulse is applied after the all-cell reset period has ended, thereby narrowing the margin of the write discharge in the following write period. In contrast, in the driving method for the PDP apparatus 1 pertaining to the present embodiment, favorable resetting can be performed without applying such an auxiliary erase pulse, thereby eliminating the narrowing of the margin of the write discharge.

Also, in the driving of the PDP apparatus employing the technology of patent document 2, an erase pulse is applied regardless of whether or not an erroneous discharge has occurred after the all-cell reset period has ended, thereby erasing the accumulated wall charge, and in some cases, leading to a situation in which a sustain discharge does not occur during a sustain period in a discharge cell that is to be lit. In contrast, in the driving method for the PDP apparatus 1 pertaining to the present embodiment, all of the discharge cells can be reliably reset even without the application of an auxiliary erase pulse such as in patent document 2, thereby eliminating cases in which a sustain discharge does not occur during a sustain period in a predetermined discharge cell that is to be lit.

Accordingly, in the driving method for the PDP apparatus 1 pertaining to the present embodiment, the generation of erroneous discharges can be reliably suppressed in the all-cell reset period T₁ without narrowing the voltage margin for generating a write discharge in the write period T₂, thereby achieving a high image quality.

Note that in the former half T₁₁ of the all-cell reset period T₁ in the present embodiment, the reset pulse Pul.2 having a ramp waveform portion is applied to the sustain electrodes Sus(1) to Sus(n) for the following reason.

As shown in FIG. 1, in the panel unit 10 of the PDP apparatus 1, the protective film 114 on the front panel 11 is exposed to the discharge space 13, and the phosphor layer 124 on the back panel 12 is exposed to the discharge space 13. Between these two layers 113 and 124 that face the discharge space 13, the protective film 114 that is composed of MgO has a greater secondary electron emission coefficient than the phosphor layer 124. Therefore, the opposing discharge that occurs with the scan electrode Scn, where the address electrode Dat is the cathode, is more unstable than the surface discharge that occurs with the scan electrode, where the sustain electrode Sus is the cathode. Furthermore, between the two opposing discharges between the scan electrode Scn and the address electrode Dat, the weak discharge in the former half T₁₁, where the address electrode Dat is the cathode, is particularly unstable. Therefore, in the present embodiment, the reset pulse operation is employed in the former half T₁₁ that causes the generation of the opposing discharge (weak discharge) where the address electrode Dat is the cathode.

According to the above, even in a variation in which the reset pulse having a ramp waveform portion is applied to the sustain electrode Sus in the latter half T₁₂, it goes without saying that the present embodiment is effective for generating a stable reset discharge.

Note that as shown in FIG. 4, in the present embodiment the timing at which the application of the reset pulse Pul.1 is started (the timing at point P1) and the timing at which the application of the reset pulse Pul.2 is started (the timing at point P11) are the same timing t0. However, there is no need for these two timings to be the same. Here, in the normal driving method, the timing of point P1 comes first, and the timing of point P11 is set so as to come in a range of 0 [μsec.] to 100 [μsec.] later. However, if within roughly 1 [μsec.], either point P1 or point P11 may come first.

Also, as shown in FIG. 4, in the present embodiment the reset operation causes the generation of a reset discharge in the former half T₁₁ in which the scan electrode Scn is the anode and the sustain electrode Sus and the address electrodes Dat are the cathode. However, the present invention is not necessarily limited to this. In an exemplary case that is the reverse of the case shown in FIG. 4, the reset operation may cause the generation of a reset discharge in the former half T₁₁ in which the scan electrode is the cathode and the sustain electrode Sus and the address electrode Dat are the anode, and the generation of a reset discharge in the latter half T₁₂ in which the scan electrode Scn is the anode and the sustain electrode Sus and the address electrode Dat are the cathode. In this case, the above effect is obtained by employing the reset operation characteristic of the present embodiment to the latter half T₁₂.

Furthermore, when employing the driving method pertaining to the present embodiment, flicker in low gradation areas can be suppressed even when raising the voltage applied to the address electrodes Dat(1) to Dat(m) during driving to a higher value than in conventional technology in order to improve definition in the panel.

6. Drive Control Performed by the Display Drive Unit 20 in the all-Cell Reset Period T₁

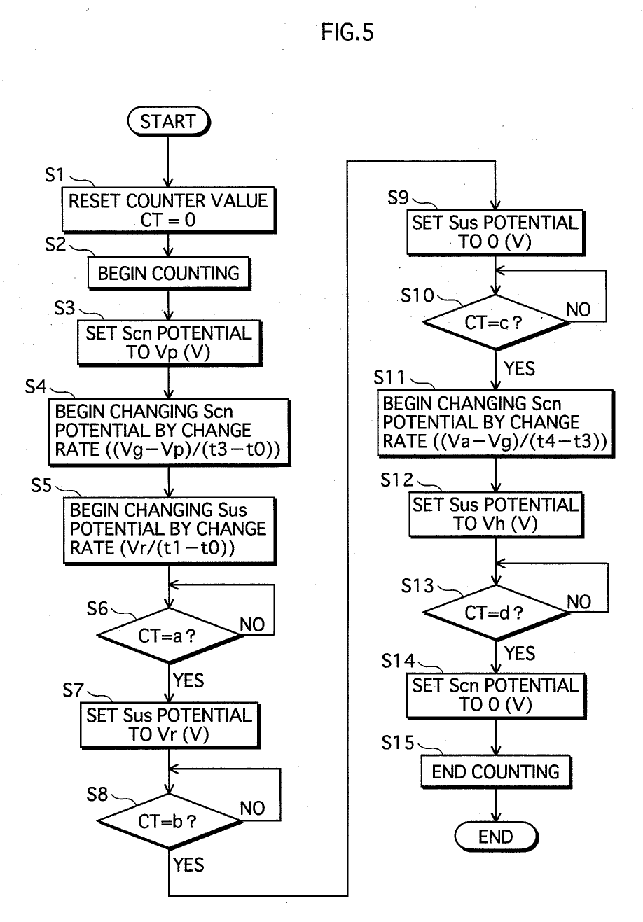

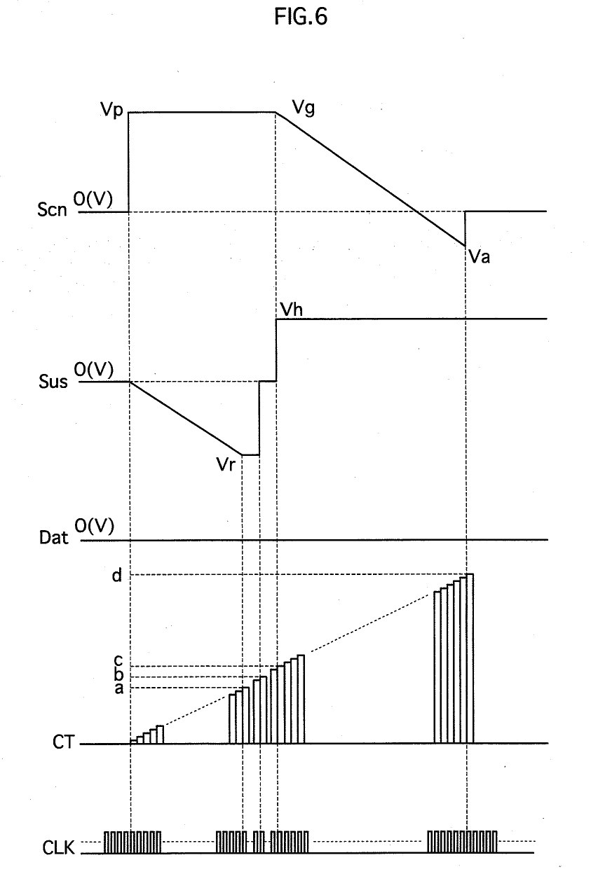

The following describes drive control processing performed by the display drive unit 20 with respect to the panel unit 10 in the all-cell reset period T₁, with reference to FIG. 5 and FIG. 6.

First, although not shown in FIG. 2, the timing generator 24 includes a clock pulse unit CLK that generates a narrow clock pulse whose interval is shorter than a difference between of the timings t0 to t8 in FIG. 4, and a counter unit that counts a sum of the clock pulses counted by the clock pulse CLK.

As shown in FIG. 5, in the drive control of the all-cell reset period T₁, the counter value CT of the counter unit is reset (step S1). At the same time, the counter begins counting up (step S2), and the potential of the scan electrodes Scn(1) to Scn(n) is set to Vp [V] (step S3). Also, when the potential of the scan electrodes Scn(1) to Scn(n) reaches Vp [V], the potential change at a voltage change rate of ((Vg−Vp)/(t3−t0)) is begun (step S4). Note that since, as mentioned above, the potential Vp [V] and the potential Vg [V] are substantially the same, the potential can be considered to be maintained at Vp [V].

Also, changing the potential of the sustain electrodes Sus(1) to Sus(n) by a negative ramp waveform having a voltage change rate of (Vr/(t1−t0)) is begun. The timing at which the potential change is begun, as mentioned above, the same as when the potential of the scan electrodes Scn(1) to Scn(n) is changed from 0 [V] to Vp [V].

The display drive unit 20 causes the potentials of the electrodes Scn(1) to Scn(n) and Sus(1) to Sus(n) to change until the counter value CT reaches “a” (step S6:NO) Then, as shown in FIG. 6, when the counter value CT reaches “a” (step S6:YES), the display drive unit 20 sets the potential of the sustain electrodes Sus(1) to Sus(n) to Vr [V], and maintains the potential at Vr [V] (step S7).

The display drive unit 20 maintains this state until the counter value CT reaches “b” (step S8:NO), and as shown in FIG. 6, when the counter value CT reaches “b”, the display drive unit 20 sets the potential of the sustain electrodes Sus(1) to Sus(n) to 0 [V] (step S9). This state is maintained until the former half T₁₁ ends, that is to say, until the counter value CT reaches “c” (step S10:NO). As shown in FIG. 6, when the counter value CT reaches “c” (step S10:YES), the display drive unit 20 begins to change the potential of the scan electrodes Scn(1) to Scn(n) by a negative ramp waveform that has a voltage change rate of ((Va−Vg)/(t4−t3)) (step S11), and furthermore sets the potential of the sustain electrodes Sus(1) to Sus(n) to the positive potential Vh [V], and maintains the potential Vh [V] (step S12).

The display drive unit 20 maintains this state until the counter value CT reaches “d” (step S13:NO). When the counter value CT reaches “d” (step S13:YES), the display drive unit 20 sets the potential of the scan electrodes Scn(1) to Scn(n) to 0 [V] (step S14), ends the counting (step S15), and ends operation control in the all-cell reset period T₁.

7. Setting Subfields SF Included in the all-Cell Reset Period T₁

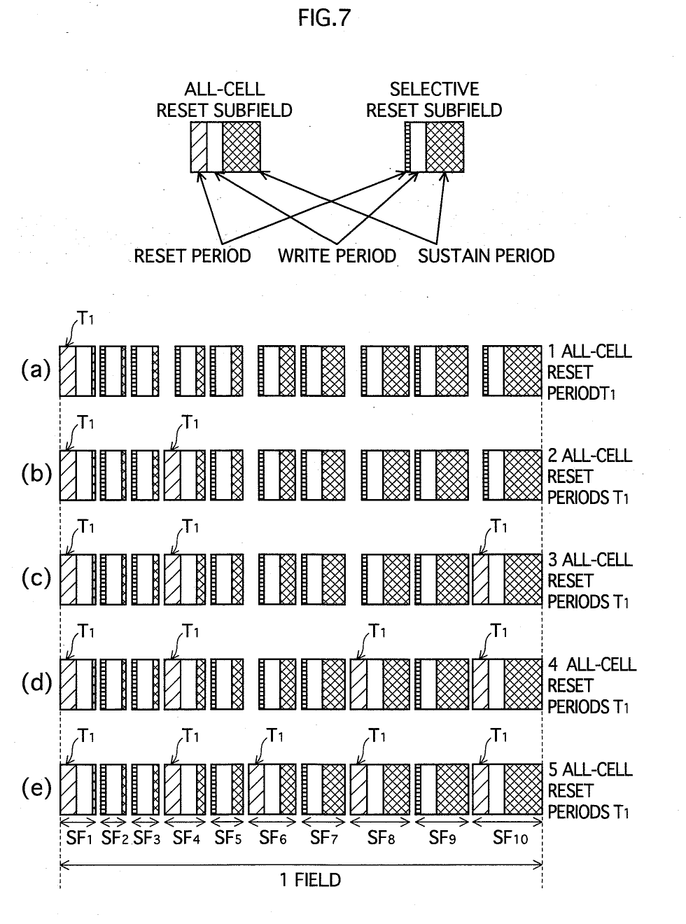

The following describes settings for subfields SF in a field in the driving method pertaining to the present embodiment, with reference to FIG. 7. FIG. 7 diagramatically shows a structure of subfields in a field in the driving of the PDP apparatus 1. Note that in FIG. 7, one field is constituted from the ten subfields SF₁ to SF₁₀.

In the driving method for the PDP apparatus 1 pertaining to the present embodiment, the structure of the subfields SF is specified based on data regarding an APL detected by the APL detector 28.

In the driving method for the PDP apparatus 1, each field includes a subfield SF that includes an all-cell reset period T₁ and a subfield SF that includes a selective reset period T₄. Also, to which portion of the field the subfield SF having the all-cell reset period T₁ is to be applied is determined based on data regarding the detected APL.

FIG. 7(a) shows the setting of subfields SF₁ to SF₁₀ that are to be applied when the APL value is in the range of 0[%] to 1.5[%]. Specifically, a subfield including an all-cell reset period T₁ has been assigned as the first subfield SF₁. Also, subfields including a selective reset period T₄ have been assigned as subfields from the second subfield SF₂ to the tenth subfield SF₁₀.

Similarly, as shown in FIG. 7(b), in addition to the first subfield SF₁, a subfield including an all-cell reset period T₁ has been applied to the fourth subfield SF₄ when the APL value is 1.5[%] to 5[%]. Also, as shown in FIG. 7(c), when the APL value is 5[%] to 10[%], a subfield including an all-cell reset period T₁ has been assigned as the tenth subfield SF₁₀, unlike when the APL value is 1.5[%] to 5[%] as shown in FIG. 7(b).

As shown in FIG. 7(d), when the APL value is 10[%] to 15[%], a subfield having an all-cell reset period T₁ has been assigned as the first, fourth, eighth, and tenth subfields SF₁, SF₄, SF₈, and SF₁₀. As shown in FIG. 7(e), when the APL value is 15[%] to 100[%], a subfield having an all-cell reset period T₁ has been assigned as the first, fourth, sixth, eighth, and tenth subfields SF₁, SF₄, SF₆, SF₈, and SF₁₀.

As described above, in the driving method for the PDP apparatus 1 pertaining to the present embodiment, subfields including an all-cell reset period T₁ are assigned based on an APL value that has been detected by the APL detector 28 (see FIG. 2). Here, when the APL value is high, the image is considered to have a small black display area. Since the number of subfields including an all-cell reset period T₁ is increased in such a situation in the driving method for the PDP apparatus 1 pertaining to the present embodiment, it is possible to increase the priming and stabilize discharges.

On the other hand, when the APL value is low, the image is considered to have a large black display area, and since the number of subfields SF having an all-cell reset period T₁ is decreased in such a situation, it is possible to ensure high-quality black display.

Accordingly, in the driving method for the PDP apparatus 1 pertaining to the present embodiment, even if there is a high brightness area, as long as the APL value is low, it is possible to have high-contrast image display with a low brightness in the black display area.

Note that the method for assigning the subfields SF having an all-cell reset period T₁ pertaining to the present embodiment shown in FIG. 7 is shown in table 1 in which the subfields are in correspondence with APL values.

TABLE 1

| | Number of | Subfields including all-cell reset period | | | | | | | | | |
|---|---|---|---|---|---|---|---|---|---|---|---|
| APL | all-cell | (◯: including, —: not including) | | | | | | | | | |
| (%) | resets | SF₁ | SF₂ | SF₃ | SF₄ | SF₅ | SF₆ | SF₇ | SF₈ | SF₉ | SF₁₀ |
| 0-1.5 | 1 | ◯ | — | — | — | — | — | — | — | — | — |
| 1.5-5 | 2 | ◯ | — | — | ◯ | — | — | — | — | — | — |
| 5-10 | 3 | ◯ | — | — | ◯ | — | — | — | — | — | ◯ |
| 10-100 | 4 | ◯ | — | — | ◯ | — | — | — | ◯ | — | ◯ |
| 15-100 | 5 | ◯ | — | — | ◯ | — | ◯ | — | ◯ | — | ◯ |

Table 1 shows an example in which there are five patterns for setting subfields SF that include an all-cell reset period T₁ based on the APL value. However, the present invention is not limited to this. The following describes variations of methods for assigning subfields that have an all-cell reset period T₁.

(Variation 1)

Table 2 shows an example in which there are four patterns for setting subfields that include an all-cell reset period T₁ based on APL values.

TABLE 2

| | Number of | Subfields including all-cell reset period | | | | | | | | | |
|---|---|---|---|---|---|---|---|---|---|---|---|
| APL | all-cell | (◯: including, —: not including) | | | | | | | | | |
| (%) | resets | SF₁ | SF₂ | SF₃ | SF₄ | SF₅ | SF₆ | SF₇ | SF₈ | SF₉ | SF₁₀ |
| 0-1.5 | 1 | ◯ | — | — | — | — | — | — | — | — | — |
| 1.5-5 | 2 | ◯ | — | — | — | — | — | — | — | ◯ | — |
| 5-10 | 3 | ◯ | — | — | ◯ | — | — | — | — | ◯ | — |
| 10-100 | 4 | ◯ | — | — | ◯ | — | — | — | ◯ | — | ◯ |

As shown in table 2, subfields including an all-cell reset period T₁ are assigned according to four patterns of the subfield assigning method pertaining to the present variation 1 based on APL values. Specifically, as shown in table 2, when the APL value is 0[%] to 1.5[%], only the first subfield SF₁ is a subfield that has an all-cell reset period T₁, and the other subfields SF₂ to SF₁₀ are subfields that have a selective reset period T₄. Also, when the APL value is 1.5[%] to 5[%], the first and ninth subfields SF₁ and SF₉ are subfields that have an all-cell reset period T₁, and when the APL value is 5[%] to 10[%], the first, fourth, and ninth subfields SF₁, SF₄, and SF₉ are subfields that have an all-cell reset period T₁. Also, when the APL value is 10[%] to 100[%], the first, fourth, eighth, and tenth subfields SF₁, SF₄, SF₈, and SF₁₀ are subfields that have an all-cell reset period T₁.

The same effects as the method shown in table 1 can be obtained by employing the method for assigning subfields that have an all-cell reset period T₁ pertaining to the present variation 1.

(Variation 2)

The following describes a method for assigning subfields that have an all-cell reset period T₁ pertaining to variation 2, with reference to table 3.

TABLE 3

| | Number of | Subfields including all-cell reset period | | | | | | | | | |
|---|---|---|---|---|---|---|---|---|---|---|---|
| APL | all-cell | (◯: including, —: not including) | | | | | | | | | |
| (%) | resets | SF₁ | SF₂ | SF₃ | SF₄ | SF₅ | SF₆ | SF₇ | SF₈ | SF₉ | SF₁₀ |
| 0-1.5 | 1 | ◯ | — | — | — | — | — | — | — | — | — |
| 1.5-5 | 2 | ◯ | — | — | ◯ | — | — | — | — | — | — |
| 5-10 | 3 | ◯ | — | — | ◯ | — | ◯ | — | — | — | — |

As shown in table 3, according to the assigning method pertaining to the present variation 2, when the APL value is 0[%] to 1.5[%], only the first subfield SF₁ is a subfield that has an all-cell reset period T₁. When the APL value is 1.5[%] to 5[%], the first and fourth subfields SF₁ and SF₄ are subfields that have an all-cell reset period T₁, and when the APL value is 5[%] to 100[%], the first, fourth, and sixth subfields SF₁, SF₄, and SF₆ are subfields that have an all-cell reset period T₁.

In the present variation 2, control is performed such that a subfield including an all-cell reset period T₁ is assigned as the subfield closest to the head of the field.

Assigning a subfield including an all-cell reset period T₁ as the subfield closest to the head of the field has advantages such as the following.

For example, in a subfield having a high number of sustain discharges, the sustain discharges make it easy for cross-talk to occur with adjacent discharge cells. For this reason, there is a reduction in the wall charge of the adjacent discharge cells that have been influenced, and there are cases in which a write discharge cannot be generated in the next subfield, thereby degrading image quality. The image degradation is particularly significant in a case in which cross-talk influences a low-gradation subfield.

For the above reason, normally in driving of a PDP apparatus, an all-cell reset period is set in a low-gradation subfield that is closest to the head of each field, and the wall charge state in the discharge cells is reliably reset even if there is cross-talk influence in the immediately preceding subfield. When this is taken into consideration, employing the subfield assigning method shown in table 3 enables suppressing writing faults due to cross-talk, and reliably suppressing image degradation.

(Modification 1)

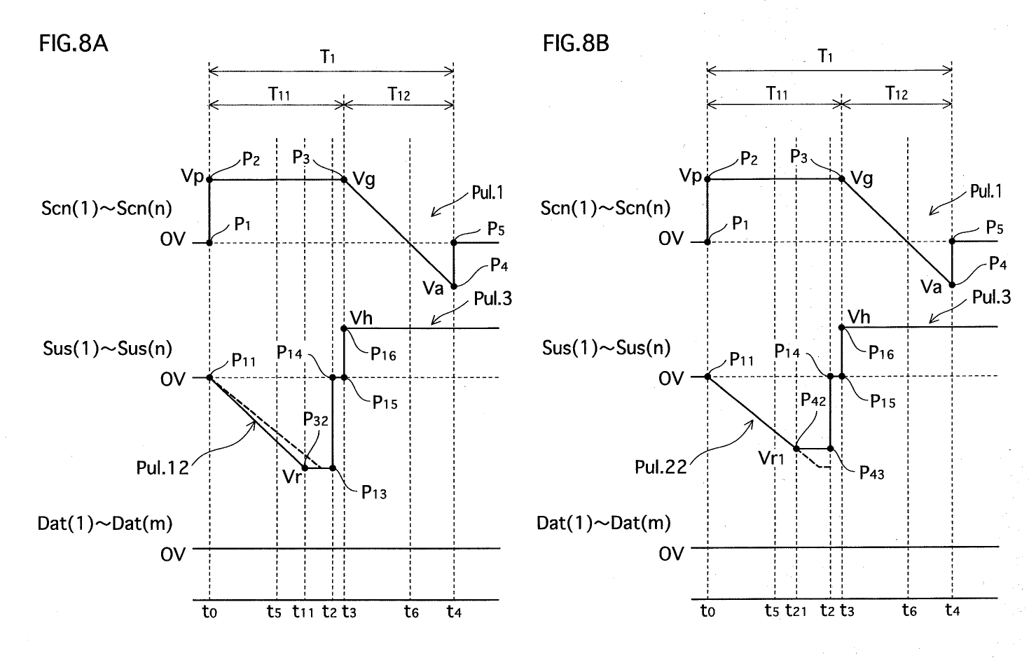

The following describes a PDP apparatus driving method pertaining to modification 1 with reference to FIG. 8A. FIG. 8A is a waveform diagram showing voltage waveforms applied to the electrodes Scn, Sus, and Dat in the all-cell reset period T₁ during driving of the PDP apparatus. Note that in modification 1, the PDP apparatus 1 and driving method for the same are the same as in embodiment 1, with the exception of the voltage waveforms in the all-cell reset period T₁.

As shown in FIG. 8A, in the driving method pertaining to modification 1, the slope of the negative ramp waveform portion of the pulse Pul.12 (the portion from point P11 to point P32) applied to the sustain electrodes Sus(1) to Sus(n) in the former half T₁₁ of the all-cell reset period T₁ is different from the PDP apparatus 1 of embodiment 1. Specifically, in the PDP apparatus driving method pertaining to modification 1, the slope of the negative ramp waveform portion of the pulse Pul.12 has been set based on the value of the APL calculated by the APL detector 28. As shown in FIG. 8A, when the slope of the negative ramp waveform portion is steep, the timing t11 when potential Vr [V] is reached comes earlier, and point P32 has been shifted further forward than in the driving method pertaining to embodiment 1.

Note that the slope of the negative ramp waveform portion of the pulse Pul.12 may be set based on the panel temperature or external temperature, or the drive time etc., instead of based on the APL value.

In the driving method of modification 1, the slope of the negative ramp waveform portion of the pulse Pul.12 is changed based on any of the above-described factors, which has the advantages of ensuring a wide margin in normal reset operations while suppressing black brightness in the driving method pertaining to the above embodiment. In other words, although dependent on the properties of the MgO in the protective film 114, generally the lower the temperature or the longer the cumulative driving time, the more easily erroneous discharges occur in the reset period. This is due to the reduction in priming particles. In consideration of this, the slope of the negative waveform portion of the pulse Pul.12 is changed based on any of the above factors, or a combination thereof, thereby achieving the above-described advantages in the driving method of the present modification.

(Modification 2)

The following describes a PDP apparatus driving method pertaining to modification 2 with reference to FIG. 8B. Note that similarly to modification 1, in modification 2 the PDP apparatus 1 and driving method for the same are the same as in embodiment 1, with the exception of the voltage waveforms in the all-cell reset period T₁.

As shown in FIG. 8B, in the driving method pertaining to modification 2, the potential Vr₁ [V] at the end point P42 of the negative ramp waveform portion of the pulse Pul.22 (the portion from point P11 to point P42) applied to the sustain electrodes Sus(1) to Sus(n) in the former half T₁₁ of the all-cell reset period T₁ is different from the PDP apparatus 1 of embodiment 1. Also, the potential is Vr₁ [V] at point P43 as well. If the slope of the negative ramp waveform portion is the same as in embodiment 1, the timing t21 at the end point P42 of the negative ramp waveform changes when the value of the potential Vr₁ [V] is changed.

In the driving method pertaining to modification 2, the value of the potential Vr₁ [V] at the end point P42 of the negative ramp waveform portion is set based on the value of the APL calculated by the APL detector 28. Note that similarly to the driving method pertaining to modification 1, in modification 2 the potential Vr₁ [V] may be changed based on the panel temperature or external temperature, or the drive time etc.

Employing the driving method of modification 2 has the advantages of employing of the driving method pertaining to embodiment 1, as well as the advantages of ensuring a wide margin in normal reset operations while suppressing black brightness. In other words, similarly to modification 1, the amplitude of the ramp waveform portion of the pulse Pul.22 is changed based on any of the above-described factors or a combination thereof, thereby enabling appropriate control of the amount of priming particles. Accordingly, a wide margin in normal reset operations can be ensured while suppressing black brightness in the driving method pertaining to modification 2 as well.

(Modification 3)

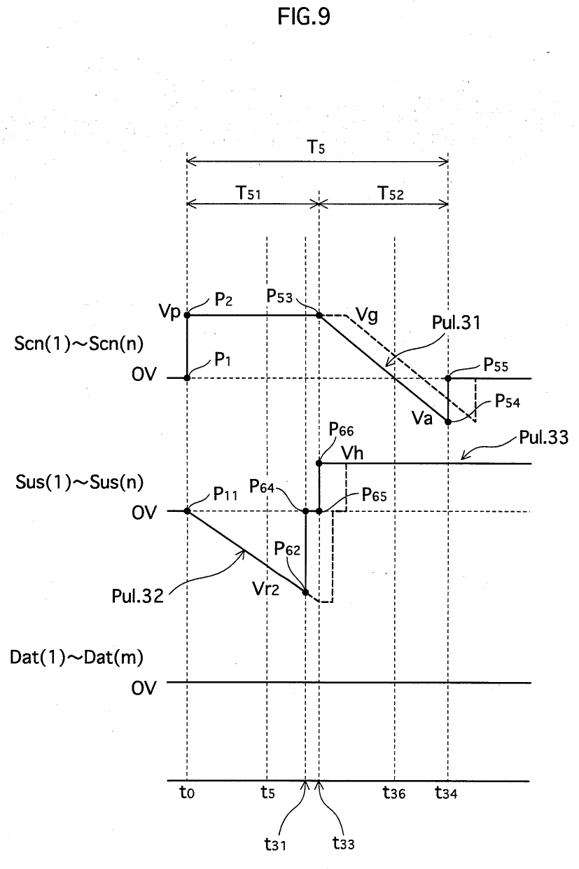

The following describes a PDP apparatus driving method pertaining to modification 3 with reference to FIG. 9. Note that similarly to modifications 1 and 2, in the driving method pertaining to modification 3 the PDP apparatus 1 and driving method for the same are the same as in embodiment 1, with the exception of the voltage waveforms applied to the electrodes Scn, Sus, and Dat in the all-cell reset period T₅.

As shown in FIG. 9, in the driving method pertaining to modification 3, the potential Vr₂ [V] at the end point P62 of the negative ramp waveform portion of the pulse Pul.32 (the portion from point P11 to point P62) applied to the sustain electrodes Sus(1) to Sus(n) in the former half T₅₁ of the all-cell reset period T₅ is different from the PDP apparatus 1 of embodiment 1. If the slope of the negative ramp waveform portion is the same as in embodiment 1, the timing t31 at the end point P62 of the negative ramp waveform changes when the value of the potential Vr₂ [V] is changed.

In the driving method pertaining to modification 3 as well, the value of potential Vr₂ [V] at end point P62 of the negative ramp waveform portion is set based on the value of the APL calculated by the APL detector 28, the panel temperature, external temperature, driving time, or a combination of such factors.

In the driving method pertaining to modification 2, the drive waveforms after timing t2 are the same as in the driving method pertaining to embodiment 1. In contrast, in the driving method pertaining to modification 3, timings t33, t36, and t34 after timing t31 have been shifted more toward the beginning of the period. In other words, in the driving method pertaining to modification 3, timing t31 changes when the potential Vr₂ [V] at point P62 is changed, and the amount of change applies to timings t33, t36, and t34 following thereafter. Therefore, in the case of FIG. 9, timings t33, t36, and t34 have been shifted toward the beginning of the period.

Furthermore, in the driving method pertaining to modification 3, the pulses Pul.32 and Pul.33 applied to the scan electrode Scn are changed as described above, and in conjunction, the portion of the pulse Pul.31 applied to the sustain electrode Sus after timing t31 has been shifted toward the beginning of the period.

According to the above characteristics, the driving method pertaining to modification 3 has the same advantages as the driving method pertaining to modification 2, as well as enables more precise control of the reset discharges. Furthermore, the driving method pertaining to modification 3 enables suppressing the length of the all-cell reset period T₅, in particular the time required for the former half T₅₁, to a minimum required length, and is suited for increasingly high-definition panels.

### Embodiment 2

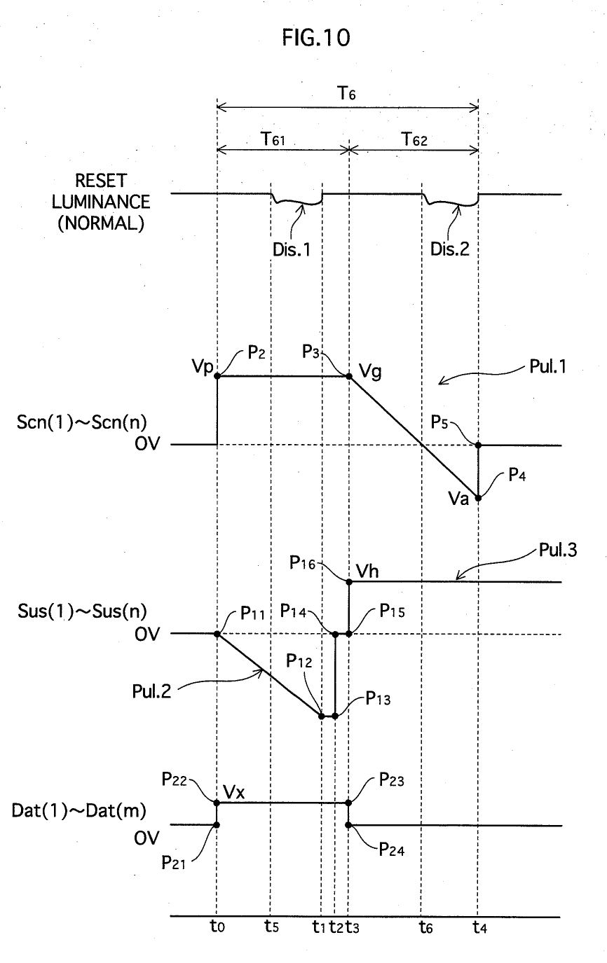

The following describes a driving method for a PDP apparatus pertaining to embodiment 2, with reference to FIG. 10. FIG. 10 is a waveform diagram showing voltage waveforms applied to the electrodes Scn(1) to Scn(n), Sus(1) to Sus(n), and Dat(1) to Dat(m) in the all-cell reset period T₆ in the driving method for the PDP pertaining to the present embodiment.

The PDP apparatus pertaining to the present embodiment has the same structure as the PDP apparatus 1, and the driving method for the same is the same as in embodiment 1, with the exception of the all-cell reset period T₆, and descriptions thereof have therefore been omitted. The following description focuses on only the all-cell reset period T₆ in the driving method.

As shown in FIG. 10, in the driving method pertaining to the present embodiment, the waveforms of the pulse Pul.1 applied to the scan electrodes Scn(1) to Scn(n) in the all-cell reset period T₆ and the waveforms of the pulses Pul.2 and Pul.3 applied to the sustain electrodes Sus(1) to Sus(n) are the same as in the driving method pertaining to embodiment 1. The characteristic feature of the driving method pertaining to the present embodiment is raising the potential of the address electrodes Dat(1) to Dat(m) to the positive potential Vx [V] in the former half T₆₁ of the all-cell reset period T₆.

Specifically, in the former half T₆₁ of the all-cell reset period T₆ in the driving method for the PDP apparatus pertaining to embodiment 2, the potential of the address electrodes Dat(1) to Dat(m) is changed from 0 [V] to Vx [V] at timing t0 (the portion from point P21 to point P22 in FIG. 10), then maintained at Vx [V] until timing t2 when the former half T₆₁ ends (the portion from point P22 to point P23), and at timing 2, the potential of the address electrodes Dat(1) to Dat(m) is changed to 0 [V] (the portion from point P23 to point P24).

Note that in the driving method for the PDP apparatus pertaining to embodiment 2, control of operations outside of the former half T₆₁ does not differ from embodiment 1.

Similarly to embodiment 1, in the driving method employing the above reset operation, a first reset discharge Dis.1 is generated in the former half T61, and a second reset discharge Dis.2 is generated in the latter half T₆₂. Also, in the former half T₆₁ that is characteristic to embodiment 2, first a weak discharge in which the scan electrodes Scn(1) to Scn(n) are each anodes and the sustain electrodes Sus(1) to Sus(n) are each cathodes is generated, and thereafter a weak discharge in which the scan electrodes Scn(1) to Scn(n) are each anodes and the address electrodes Dat(1) to Dat(m) are each cathodes can be generated. This mechanism is the same as in embodiment 1.

In the former half T₆₁ of the all-cell reset period T₆ in embodiment 2, the potential of the address electrodes Dat(1) to Dat(m) is maintained at Vx [V], thereby enabling more reliably generating a weak discharge between the scan electrodes Scn(1) to Scn(n) and the sustain electrodes Sus(1) to Sus(n) than in the driving method pertaining to embodiment 1. Accordingly, the driving method for the PDP apparatus 1 pertaining to embodiment 2 enables more reliably preventing the generation of erroneous discharges than even the driving method pertaining to embodiment 1.

Also, when employing the driving method pertaining to the present embodiment, the flickering in low gradation areas can be prevented even when the voltage applied to the address electrodes Dat(1) to Dat(m) during driving is raised higher than in conventional technology in order to achieve a panel with higher definition.

Note that in the driving method pertaining to embodiment 2, there is the possibility of a change in the order in which the weak discharges occur, depending on the method of setting the waveform of the pulses applied to the electrodes Scn(1) to Scn(n), Sus(1) to Sus(n), and Dat(1) to Dat(m) in the all-cell reset period T₆. For example, if the potential Vx [V] shown in FIG. 10 is set sufficiently high, it is possible to assume that the weak discharge between the sustain electrodes Sus(1) to Sus(n) and the address electrodes Dat(1) to Dat(m) will occur before the weak discharge between the scan electrodes Scn(1) to Scn(n) and the sustain electrodes Sus(1) to Sus(n).

However, even in a case such as above in which the order of the weak discharges changes, the weak discharge between the sustain electrodes Sus(1) to Sus(n) and the address electrodes Dat(1) to Dat(m) is a discharge in which the address electrodes Dat(1) to Dat(m) are anodes, and the sustain electrodes Sus(1) to Sus(n) are cathodes. For this reason, this discharge (opposing discharge) is much more stable than an opposing discharge in which the scan electrodes Scn(1) to Scn(n) are each the anode and the address electrodes Dat(1) to Dat(m) are each the cathode. The reason for this is, as previously mentioned, the difference between the secondary electron emission coefficients of the protective film 114 and the phosphor layer 124.

(Other Remarks)

Although the structure, operations, and effects of the present invention have been described above based on the two embodiments 1 and 2 and the three variations 1 to 3, the present invention is not limited to these. For example, although in embodiments 1 and 2 the application of the pulse Pu.1 to the scan electrodes Scn(1) to Scn(n) and the application of the pulse Pul.2 to the sustain electrodes Sus(1) to Sus(n) are started simultaneously at timing t0, the applications do not necessarily need to be performed simultaneously. For example, point P1 of FIG. 4 may come before point P11, or may come after point P11. However, it is desirable to set the time difference between points P1 and P11 to, for example, 1 [nsec.] to 1000 [nsec.] since too large of a time difference has an adverse effect on the generation of reset discharges.

Also, in addition to the apparatus structure shown in FIG. 2, the PDP apparatus of the present invention may be provided with a panel temperature monitoring unit that monitors the temperature of the panel unit 10, the number and durations of subfields including all-cell reset periods T₁, T₅, and T₆ in a field may be set based on temperature information, and the amplitude of the potential Vr [V] of the reset pulse Pul.2 and the voltage change rate (slope) of a portion thereof from point P11 to point P12 may be set based on temperature information.

Also, the PDP apparatus of the present invention may be provided with a drive time counting unit that counts a drive time in the PDP apparatus, and also counts a cumulative drive time. In the case of such a structure, the number and durations of subfields including all-cell reset periods T₁, T₅, and T₆ in a field may be set based on the cumulative value, and the amplitude of the potential Vr [V] of the reset pulse Pul.2 and the voltage change rate (slope) of a portion thereof from point P11 to point P12 may be set based on the cumulative value.

Also, the present invention can be applied to a plasma display panel apparatus that has an HD (High Definition) resolution or higher, and a driving method therefor, and the above-described effects can be obtained in such a case. Here, a plasma display panel apparatus that has an HD resolution or higher refers to, for example, the following.
for a 37-inch panel size: a panel having a higher resolution than a 1024×720 [pixel] HD panel
for a 42-inch panel size: a panel having a higher resolution than a 1024×768 [pixel] HD panel
for a 50-inch panel size: a panel having a higher resolution than a 1366×768 [pixel] HD panel

Also, “a panel that has an HD resolution or higher” includes a Full-HD panel (1920×1080 [pixels]).

Furthermore, although exemplary phosphor materials constituting the phosphor layers 124R, 124G and 124B were described in embodiment 1 etc., other phosphor materials such as the following can be used.

R phosphor: (Y,Gd)BO₃:Eu

G phosphor: compound of (Y,Gd)BO₃:Tb and Zn₂SiO₄:Mn

B phosphor: BaMg₂Al₁₄O₂₄:Eu

Furthermore, the driving methods pertaining to variations 1 and 2 can be applied in combination with the PDP apparatus driving method pertaining to embodiment 2.

### INDUSTRIAL APPLICABILITY

The present invention can be applied to a display device such as a television or computer monitor for which high definition and a high image quality are required.

1. A driving method for a plasma display panel apparatus which includes a panel unit (i) that has a plurality of electrode pairs, each including a first electrode and a second electrode, (ii) that has a plurality of third electrodes which cross the electrode pairs with a discharge space therebetween, and (iii) in which a plurality of discharge cells are constituted at a plurality of intersecting portions between the electrode pairs and the third electrodes, an all-cell reset period for resetting a wall charge state of all of the discharge cells being assigned in a field that includes a plurality of brightness-weighted subfields, wherein
the all-cell reset period is divided into a first section in which a first reset discharge is generated and a second section in which a second reset discharge is generated,
in at least one of the first section and the second section, a change in a potential of the first electrodes is begun, the change being toward a potential that is less than a discharge starting voltage between the first electrodes and the third electrodes, and in conjunction with a timing thereof, a potential of the second electrodes is changed inversely with respect to a polarity of the potential of the first electrode by a ramp waveform portion of a voltage waveform applied to the second electrodes, and
a duration of the ramp waveform portion from a beginning to an end of the potential change of the second electrodes is longer than a duration from when the potential change of the first electrodes is begun until the potential that is less than the discharge starting voltage has been reached.

2. The driving method for the plasma display panel apparatus of claim 1, wherein
in the first reset discharge of the first section, the first electrodes are anodes and the second electrodes are cathodes, and
the ramp waveform portion of the voltage waveform applied to the second electrodes is set in at least the first section and has a negative slope in the at least first section.

3. The driving method for the plasma display panel apparatus of claim 1, wherein
in the at least one of the first section and the second section in which the voltage waveform having the ramp waveform portion is applied to the second electrodes, the potential of the third electrodes is changed toward a potential having the same polarity as the potential of the first electrodes.

4. The driving method for the plasma display panel apparatus of claim 1, wherein
the all-cell reset period is assigned to a subfield from among the plurality of subfields in accordance with an average picture level of an image of the field.

5. The driving method for the plasma display panel apparatus of claim 1, wherein
a slope of the ramp waveform portion is set in accordance with any of an average picture level of an image of the field that includes the all-cell reset period, a panel temperature, and a drive time.

6. The driving method for the plasma display panel apparatus of claim 1, wherein
a potential of the second electrodes at an end of the potential change by the ramp waveform portion is set in accordance with any of an average picture level of an image of the field that includes the all-cell reset period, a panel temperature, and a drive time.

7. The driving method for the plasma display panel apparatus of claim 1, wherein
the potential change by the ramp waveform portion of the voltage waveform applied to the second electrodes is begun less than or equal to 1 μsec before/after the timing at which the potential change of the first electrodes is begun.

8. A plasma display panel apparatus comprising (i) a panel unit that has a plurality of electrode pairs, each including a first electrode and a second electrode, that has a plurality of third electrodes which cross the electrode pairs with a discharge space therebetween, and in which a plurality of discharge cells are constituted at a plurality of intersecting portions between the electrode pairs and the third electrodes, and (ii) a drive unit operable to perform display driving with respect to the panel unit by a method in which an all-cell reset period for resetting a wall charge state of all of the discharge cells is assigned in a field that includes a plurality of brightness-weighted subfields, wherein
in the display driving performed by the drive unit,
the all-cell reset period is divided into a first section in which a first reset discharge is generated and a second section in which a second reset discharge is generated,
in at least one of the first section and the second section, a change in a potential of the first electrodes is begun, the change being toward a potential that is less than a discharge starting voltage between the first electrodes and the third electrodes, and in conjunction with a timing thereof, a potential of the second electrodes is changed inversely with respect to a polarity of the potential of the first electrode by a ramp waveform portion of a voltage waveform applied to the second electrodes, and
a duration of the ramp waveform portion from a beginning to an end of the potential change of the second electrodes is longer than a duration from when the potential change of the first electrodes is begun until the potential that is less than the discharge starting voltage has been reached.

9. The plasma display panel apparatus of claim 8, wherein
in the first reset discharge of the first section, the first electrodes are anodes and the second electrodes are cathodes, and
the ramp waveform portion of the voltage waveform applied to the second electrodes is set in at least the first section and has a negative slope in the at least first section.

10. The plasma display panel apparatus of claim 8, wherein
in the at least one of the first section and the second section in which the voltage waveform having the ramp waveform portion is applied to the second electrodes, the potential of the third electrodes is changed toward a potential having the same polarity as the potential of the first electrodes.

11. The plasma display panel apparatus of claim 8, wherein
the all-cell reset period is assigned to a subfield from among the plurality of subfields in accordance with an average picture level of an image of the field.

12. The plasma display panel apparatus of claim 8, wherein
a slope of the ramp waveform portion is set in accordance with any of an average picture level of an image of the field that includes the all-cell reset period, a panel temperature, and a drive time.

13. The plasma display panel apparatus of claim 8, wherein
a potential of the second electrodes at an end of the potential change by the ramp waveform portion is set in accordance with any of an average picture level of an image of the field that includes the all-cell reset period, a panel temperature, and a drive time.

14. The plasma display panel apparatus of claim 8, wherein
the potential change by the ramp waveform portion of the voltage waveform applied to the second electrodes is begun less than or equal to 1 μsec before/after the timing at which the potential change of the first electrodes is begun.

15. The plasma display panel apparatus of claim 8, wherein
a discharge gas including at least xenon has been filled in the discharge space.
